(19) United States
(12) Patent Application Publication
(10) Pub. No.: US 2012/0259633 A1
(43) Pub. Date: Oct. 11, 2012

(54) AUDIO-INTERACTIVE MESSAGE EXCHANGE

(75) Inventors: Liane Aihara, Menlo Park, CA (US); Shane Landry, Woodinville, WA (US); Lisa Stifelman, Palo Alto, CA (US); Madhusudan Chinthakunta, Saratoga, CA (US); Anne Sullivan, San Francisco, CA (US); Kathleen Lee, San Francisco, CA (US)

(73) Assignee: MICROSOFT CORPORATION, Redmond, WA (US)

(21) Appl. No.: 13/081,679

(22) Filed: Apr. 7, 2011

(51) Int. Cl. G10L 15/26

(52) U.S. Cl. 704/235; 704/E15.043

(57) ABSTRACT

A completely hands free exchange of messages, especially in portable devices, is provided through a combination of speech recognition, text-to-speech (TTS), and detection algorithms. An incoming message may be read aloud to a user and the user enabled to respond to the sender with a reply message through audio input upon determining whether the audio interaction mode is proper. Users may also be provided with options for responding in a different communication mode (e.g., a call) or perform other actions. Users may further be enabled to initiate a message exchange using natural language.

### BACKGROUND

With the development and wide use of computing and networking technologies, personal and business communications have proliferated in quantity and quality. Multi-modal communications through fixed or portable computing devices such as desktop computers, vehicle mount computers, portable computers, smart phones, and similar devices are a common occurrence. Because many facets of communications are controlled through easily customizable software/hardware combinations, previously unheard-of features are available for use in daily life. For example, integration of presence information into communication applications enables people to communicate with each other more efficiently. Simultaneous reduction in size and increase in computing capabilities enables use of smart phones or similar handheld computing devices for multi-modal communications including, but not limited to, audio, video, text message exchange, email, instant messaging, social networking posts/updates, etc.

One of the results of the proliferation of communication technologies is the information overload. It is not unusual for a person to exchange hundreds of emails, participate in numerous audio or video communication sessions, and exchange a high number of text messages every day. Given the expansive range of communications, text message exchange is increasingly becoming more popular in place of more formal emails and time consuming audio/video communications. Still, using conventional typing technologies—whether on physical keyboards or using touch technologies—even text messaging may be inefficient, impractical, or dangerous in some cases (e.g., while driving).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing a completely hands free exchange of messages, especially in portable devices through a combination of speech recognition, text-to-speech (TTS), and detection algorithms. According to some embodiments, an incoming message may be read aloud to a user and the user enabled to respond to the sender with a reply message through audio input. Users may also be provided with options for responding in a different communication mode (e.g., a call) or perform other actions. According to other embodiments, users may be enabled to initiate a message exchange using natural language.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating networked communications between different example devices in various modalities;

FIG. 2 illustrates an example flow of operations in a system according to embodiments for initiating a message exchange through audio input;

FIG. 3 illustrates an example flow of operations in a system according to embodiments for responding to an incoming a message through audio input;

FIG. 4 illustrates an example user interface of a portable computing device for facilitating communications;

FIG. 5 is a networked environment, where a system according to embodiments may be implemented; and

FIG. 6 is a block diagram of an example computing operating environment, where embodiments may be implemented.

### DETAILED DESCRIPTION

As briefly described above, an incoming message may be read aloud to a user and the user enabled to respond to the sender with a reply message through audio input upon determining whether the audio interaction mode is proper. Users may also be provided with options for responding in a different communication mode (e.g., a call) or perform other actions. Users may further be enabled to initiate a message exchange using natural language. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for facilitating multi-modal communications. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network.

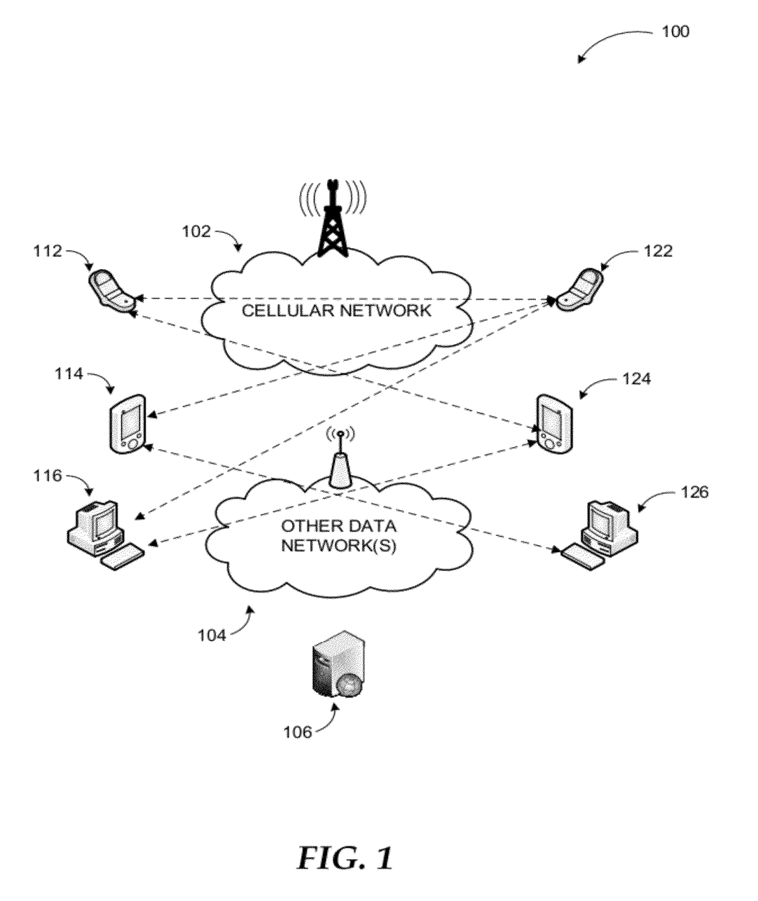

FIG. 1 is a conceptual diagram illustrating networked communications between different example devices in various modalities. Modern communication systems may include exchange of information over one or more wired and/or wireless networks managed by servers and other specialized equipment. User interaction may be facilitated by specialized devices such as cellular phones, smart phones, dedicated devices, or by general purpose computing devices (fixed or portable) that executed communication applications.

The diversity in capabilities and features offered by modern communication systems enables users to take advantage of a variety of communication modalities. For example, audio, video, email, text message, data sharing, application sharing, and similar modalities can be used individually or in combination through the same device. A user may exchange text messages through their portable device and then continue a conversation with the same person over a different modality.

Diagram 100 illustrates two example systems, one utilizing a cellular network, the other utilizing data networks. A cellular communication system enables audio, video, or text base exchanges to occur through cellular networks 102 managed by a complex backbone system. Cellular phones 112 and 122 may have varying capabilities. These days, it is not uncommon for a smart phone to be very similar to a desktop computing device in terms of capabilities.

Data network 104 based communication systems on the other hand enable exchange of a broader set of data and communication modalities through portable (e.g. handheld computers 114, 124) or stationary (e.g. desktop computers 116, 126) computing devices. Data network 104 based communication systems are typically managed by one or more servers (e.g. server 106). Communication sessions may also be facilitates across networks. For example, a user connected to data network 104 may initiate a communication session (in any modality) through their desktop communication application with a cellular phone user connected to cellular network 102.

Conventional systems and communication devices are, however, mostly limited to physical interaction such as typing or activation of buttons or similar control elements on the communication device. While speech recognition based technologies are in use in some systems, the users typically have to activate those by pressing a button. Furthermore, the user has to place the device/application in the proper mode before using the speech-based features.

A communication system according to some embodiments employs a combination of speech recognition, dictation, and text-to-speech (audio output) technologies in enabling a user to send an outgoing text-based messages and to reply to an incoming text-based message (receive notification, have the message read to them, and craft a response) without having to press any buttons or even look at the device screen, thereby rendering minimal to no interaction with the communication device. Text-based messages may include any form of textual messages including, but not limited to, instant messages (IMs), short message service (SMS) messages, multimedia messaging service (MMS) messages, social networking posts/updates, emails, and comparable ones.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

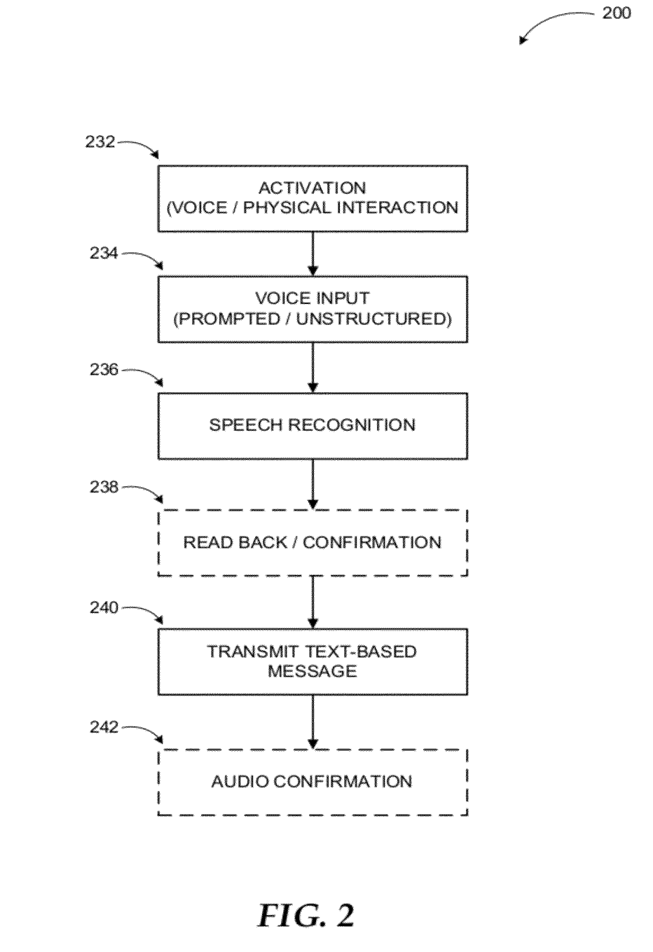

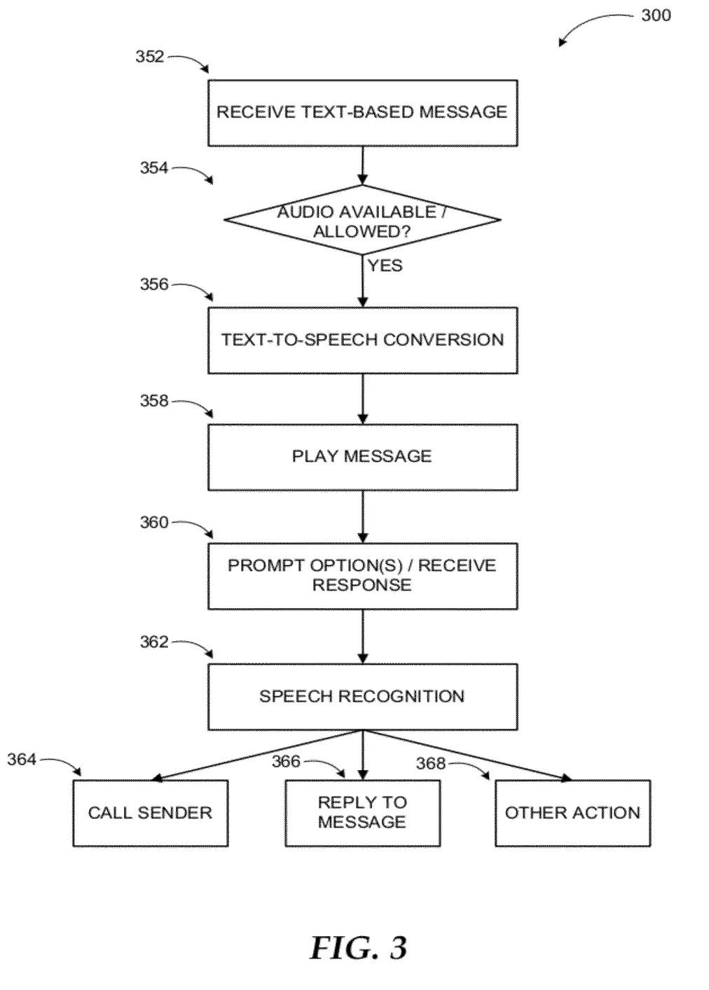

FIG. 2 illustrates an example flow of operations in a system according to embodiments for initiating a message exchange through audio input. An audio input to a computing device facilitating communications may come through an integrated or distinct component (wired or wireless) such as a microphone, a headset, a car kit, or similar audio devices. While a variety of sequences of operations may be performed in a communication system according to embodiments, two example flows are discussed in FIG. 2 and FIG. 3.

The example operation flow 200 may begin with activation of messaging actions through a predefined keyword (e.g. “Start Messaging”) or pressing of a button on the device (232). According to some embodiments, the messaging actions may be launched through natural language. For example, the user may provide an indication by uttering “Send a message to John Doe.” If the user utters a phone number or similar identifier as recipient, the system may confirm that the identifier is proper and wait for further voice input. If the user utters a name, one or more determination algorithms may be executed to associate the received name with a phone number of similar identifier (e.g., a SIP identifier). For example, the received name may be compared to a contacts list or similar database. If there are multiple names or similar sounding names, the system may prompt the user to specify which contact is intended to receive the message. Furthermore, if there are multiple identifiers associated with a contact (e.g., telephone number, SIP identifier, email address, social networking address, etc.), the system may again prompt the user to select (through audio input) the intended identifier. For example, the system may automatically determine that a text message is not to be sent to a fax number of regular phone number associated with a contact, but if the contact has two cellular phone numbers, the user may be prompted to select between the two numbers.

Once the intended recipient's identifier is determined, the system may prompt the user through an audio prompt or earcon to speak the message (234). An earcon is a brief, distinctive sound (usually a synthesized tone or sound pattern) used to represent a specific event. Earcons are a common feature of computer operating systems, where a warning or an error message is accompanied by a distinctive tone or combination of tones. When the user is done speaking the message (determined either by a duration of silence at the end exceeding a predefined time interval or user audio prompt such as “end of message”), the system may perform speech recognition (236). Speech recognition and/or other processing may be performed entirely or partially at the communication device. For example, in some applications, the communication device may send the recorded audio to a server, which may perform the speech recognition and provide the results to the communication device.

Upon conclusion of the speech recognition process, the device/application may optionally read back the message and prompt the user to edit/append/confirm that message (238). Upon confirmation, the message may be transmitted as a text-based message to the recipient (240) and the user optionally provided a confirmation that the text-based message has been sent (242). At different stages of the processing, the user interface of the communication device/application may also provide visual feedback to the user. For example, various icons and/or text may be displayed indicating an action being performed or its result (e.g. an animated icon indicating speech recognition in process or a confirmation icon/text).

FIG. 3 illustrates an example flow of operations in a system according to embodiments for responding to an incoming a message through audio input.

The operations in diagram 300 begin with receipt of a text-based message (352). Next, the system may make a determination (354) whether audio interaction mode is available or allowed. For example, the user may turn off audio interaction mode when he/she is in a meeting or in a public place. According to some embodiments, the determination may be made automatically based on a number of factors. For example, the user's calendar indicating a meeting may be used to turn off the audio interaction mode or the device being mobile (e.g. through GPS or similar location service) may prompt the system to activate the audio interaction mode. Similarly, the device's position (e.g., the device being face down) or comparable circumstances may also be used to determine whether the audio interaction mode should be used or not. Further factors in determining audio-interactive mode may include, but are not limited to, a mobile status of the user (e.g., is the user stationary, walking, driving), an availability status of the user (as indicated in the user's calendar or similar application), and a configuration of the communication device (e.g., connected input/output devices).

If the audio interaction mode is allowed/available, the received text-based message may be converted to audio content through text-to-speech conversion (356) at the device or at a server, and the audio message played to the user (358). Upon completion of the playing of the message, the device/application may prompt the user with options (360) such as recording a response message, initiating an audio call (or video call), or performing comparable actions. For example, the user may request that contact details of the sender be provided through audio or an earlier message in a string of messages be played back. The sender's name and/or identifier (e.g. phone number) may also be played to the user at the beginning or at the end of the message.

Upon playing the options to the user, the device/application may switch to a listening mode and wait for audio input from the user. When the user's response is received, speech recognition may be performed (362) on the received audio input and depending on the user's response, one of a number of actions such as placing a call to the sender (364), replying to the text message (366), or other actions (368) may be performed. Similar to the flow of operations in FIG. 2, visual cues may be displayed during the audio interaction with the user such as icons, text, color warnings, etc.

The interactions in operation flows 200 and 300 may be completely automated allowing the user to provide audio input through natural language or prompted (e.g. the device providing audio prompts at various stages). Moreover, physical interaction (pressing of physical or virtual buttons, text prompts, etc.) may also be employed at different stages of the interaction. Furthermore, users may be provided with the option of editing outgoing messages upon recording of those (following optional playback).

The operations included in processes 200 and 300 are for illustration purposes. Audio-interactive message exchange may be implemented by similar processes with fewer or additional steps, as well as in different order of operations using the principles described herein.

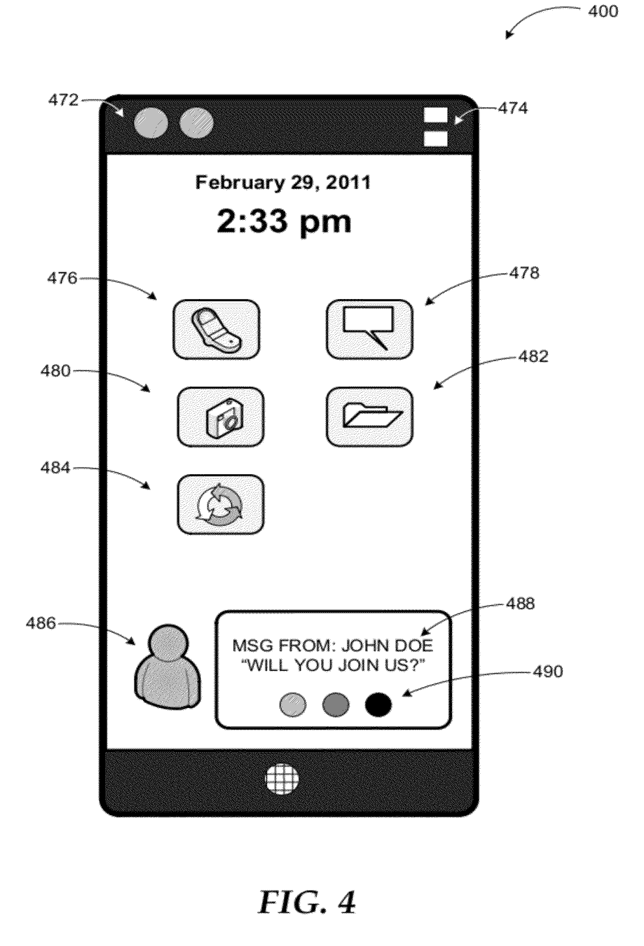

FIG. 4 illustrates an example user interface of a portable computing device for facilitating communications. As discussed above, audio interaction for text messaging may be implemented in any device facilitating communications. The user interface illustrated in diagram 300 is just an example user interface of a mobile communication device. Embodiments are not limited to this example user interface or others discussed above.

An example mobile communication device may include a speaker 472 and a microphone in addition to a number of physical control elements such as buttons, knobs, keys, etc. Such a device may also include a camera 474 or similar ancillary devices that may be used in conjunction with different communication modalities. The example user interface displays date and time and a number of icons for different applications such as phone application 476, messaging application 478, camera application 480, file organization application 482, and web browser 484. The user interface may further include a number of virtual buttons (not shown) such as Dual Tone Multi-frequency (DTMF) keys for placing a call.

At the bottom portion of the example user interface icons and text associated with a messaging application are shown. For example, a picture (or representative icon) 486 of the sender of the received message may be displayed along with a textual clue about the message 488 and additional icons 490 (e.g. indicating message category, sender's presence status, etc.)

At different stages of the processing, the user interface of the communication device/application may also provide visual feedback to the user. For example, additional icons and/or text may be displayed indicating an action being performed or its result (e.g. an animated icon indicating speech recognition in process or a confirmation icon/text).

The communication device may also be equipped to determine whether the audio interaction mode should/can be used or not. As discussed above, a location and/or motion determination system may detect whether the user is moving (e.g. in a car) based on Global Positioning Service (GPS) information, cellular tower triangulation, wireless data network node detection, compass, and acceleration sensors, matching of camera input to known geo-position photos, and similar methods. Another approach may include determining the user's location (e.g. a meeting room or a public space) and activating the audio interaction based on that. Similarly, information about the user such as from a calendaring application or a currently executed application may be used to determine the user's availability for audio interaction.

The communication employing audio interaction may be facilitated through any computing device such as desktop computers, laptop computers, notebooks; mobile devices such as smart phones, handheld computers, wireless Personal Digital Assistants (PDAs), cellular phones, vehicle mount computing devices, and similar ones.

The different processes and systems discussed in FIG. 1 through 4 may be implemented using distinct hardware modules, software modules, or combinations of hardware and software. Furthermore, such modules may perform two or more of the processes in an integrated manner While some embodiments have been provided with specific examples for audio-interactive message exchange, embodiments are not limited to those. Indeed, embodiments may be implemented in various communication systems using a variety of communication devices and applications and with additional or fewer features using the principles described herein.

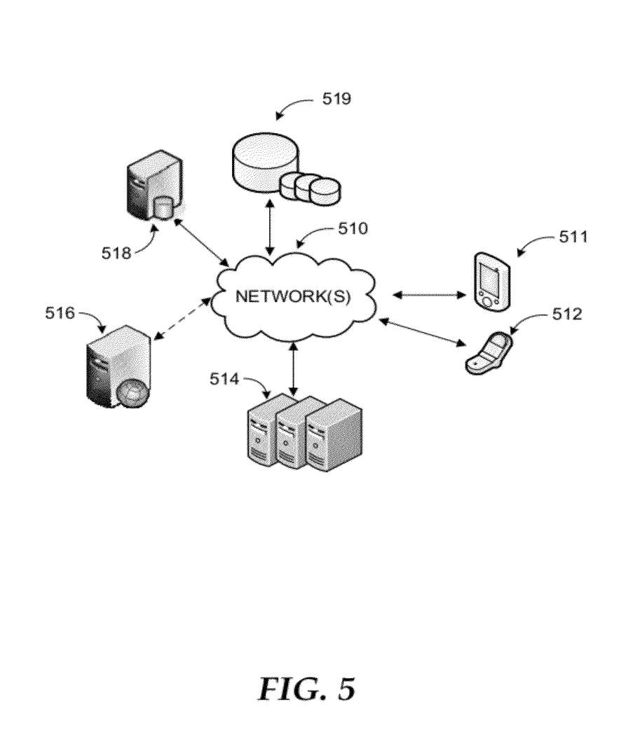

FIG. 5 is an example networked environment, where embodiments may be implemented. A platform for providing communication services with audio-interactive message exchange may be implemented via software executed over one or more servers 514 such as a hosted service. The platform may communicate with client applications on individual mobile devices such as a smart phone 511, cellular phone 512, or similar devices (‘client devices’) through network(s) 510.

Client applications executed on any of the client devices 511-512 may interact with a hosted service providing communication services from the servers 514, or on individual server 516. The hosted service may provide multi-modal communication services and ancillary services such as presence, location, etc. As part of the multi-modal services, text message exchange may be facilitated between users with audio-interactivity as described above. Some or all of the processing associated with the audio-interactivity such as speech recognition or text-to-speech conversion may be performed at one of more of the servers 514 or 516. Relevant data such as speech recognition, text-to-speech conversion, contact information, and similar data may be stored and/or retrieved at/from data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also include (especially between the servers and the mobile devices) cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to implement a platform providing audio-interactive message exchange services. Furthermore, the networked environments discussed in FIG. 5 are for illustration purposes only. Embodiments are not limited to the example applications, modules, or processes.

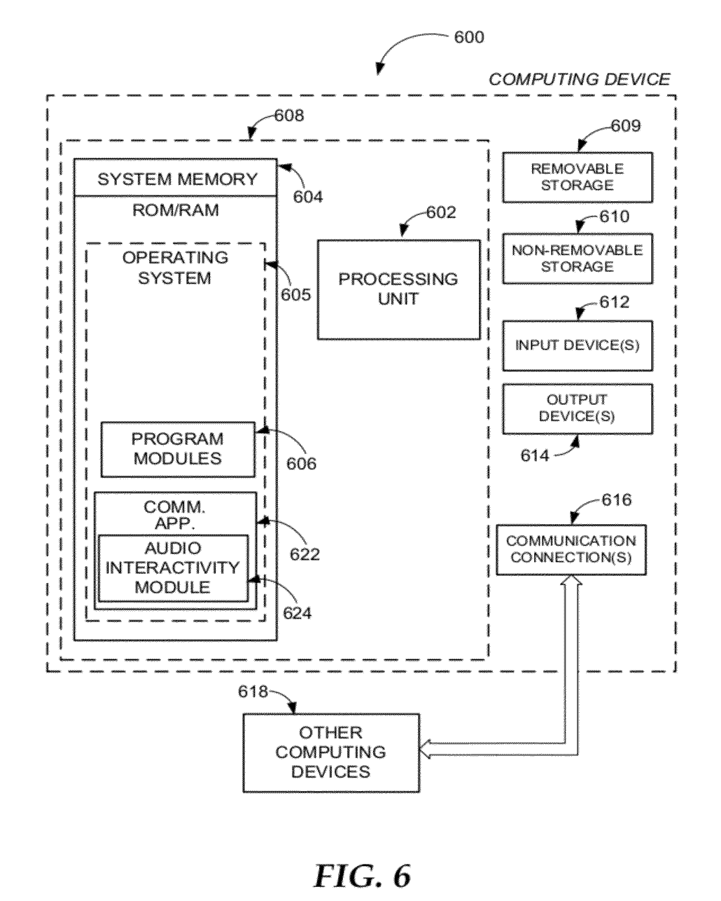

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be a mobile computing device capable of facilitating multi-modal communication including text message exchange with audio interactivity according to embodiments and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS MOBILE®, WINDOWS PHONE®, or similar operating systems from MICROSOFT CORPORATION of Redmond, Wash. or similar ones. The system memory 604 may also include one or more software applications such as program modules 606, communication application 622, and audio interactivity module 624.

Communication application 622 may enable multi-modal communications including text messaging. Audio interactivity module 624 may play an incoming message to a user and enable the user to respond to the sender with a reply message through audio input through a combination of speech recognition, text-to-speech (TTS), and detection algorithms. Communication application 622 may also provide users with options for responding in a different communication mode (e.g., a call) or for performing other actions. Audio interactivity module 624 may further enable users to initiate a message exchange using natural language. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wired or wireless network in a distributed computing environment, a satellite link, a cellular link, a short range network, and comparable mechanisms. Other devices 618 may include computer device(s) that execute communication applications, other servers, and comparable devices. Communication connection(s) 616 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for facilitating audio-interactive message exchange, the method comprising:
receiving an indication from a user to send a message;
enabling the user to provide a recipient of the message and an audio content of the message through audio input;
performing speech recognition on the received audio input;
determining the recipient from the speech recognized audio input; and
transmitting the speech recognized content of the message to the recipient as a text-based message.

2. The method of claim 1, further comprising:
receiving a text-based message from a sender;
generating an audio content from the received message by text-to-speech conversion;
playing the audio content to the user;
providing at least one option to the user associated with the played audio content; and
in response to receiving another audio input from the user, performing an action associated with the at least one option.

3. The method of claim 2, further comprising:
enabling the user to provide the indication to send the text-based message and the audio inputs using natural language.

4. The method of claim 2, further comprising:
upon receiving the audio inputs, playing back the received audio inputs; and
enabling the user to one of: edit the provided audio input and confirm the provided audio input.

5. The method of claim 2, wherein the action includes one from a set of: initiating an audio communication session with the sender, initiating a video communication session with the sender, replying with a text-based message, playing back a previous message, and providing information associated with the sender.

6. The method of claim 2, further comprising:
playing back at least one of a name and an identifier of the sender to the user along with the audio content of the received message.

7. The method of claim 1, wherein determining the recipient further comprises:
comparing a received name to a list of contacts associated with the user;
if more than one similar name exists in the list of contacts, prompting the user to select among the similar names; and
if more than on identifier exists for the received name, prompting the user to select among the identifiers.

8. The method of claim 1, further comprising:
providing one of an audio prompt and an earcon to the user upon completing each operation associated with the audio-interactive message exchange.

9. The method of claim 1, wherein the indication includes a predefined keyword.

10. The method of claim 1, further comprising:
determining an end of the audio input through one of: a silence exceeding a predefined time interval and another predefined keyword from the user.

11. The method of claim 1, further comprising:
displaying a visual clue comprising at least one of an icon and a text representing at least one operation associated with the audio-interactive message exchange.

12. The method of claim 1, further comprising:
activating an audio interaction mode automatically based on at least one from a set of: a setting of a communication device facilitating the text-based message exchange, a location of the user, a status of the user, and a user input.

13. A computing device capable of facilitating audio-interactive message exchange, the computing device comprising:
a communication module;
an audio input/output module;
a memory; and
a processor coupled to the communication module, the audio input/output module, and the memory adapted to execute a communication application that is configured to:
receive a text-based message from a sender;
generate an audio content from the received message by text-to-speech conversion;
play the audio content and one of a name and an identifier associated with the sender to the user;
provide at least one option to the user associated with the played audio content; and
in response to receiving an audio input from the user, perform an action associated with the at least one option.

14. The computing device of claim 13, wherein the communication application is further configured to:
receive an audio indication from the user to send a text-based message;
enable the user to provide a recipient of the text-based message and an audio content of the message through natural language input;
perform speech recognition on the received input;
enable the user to one of: confirm and edit the message by playing back the received input;
determine the recipient from the speech recognized content of the input; and
transmit the speech recognized content of the text-based message to the recipient.

15. The computing device of claim 13, further comprising a display, wherein the communication application is further configured to provide a visual feedback to the user through the display including at least one of a text, a graphic, an animated graphic, and an icon representing an operation associated with the audio-interactive message exchange.

16. The computing device of claim 13, wherein the communication application is further configured to activate an audio interaction mode based on at least one from a set of: a mobile status of the user, a setting of the computing device, and a position of the computing device.

17. The computing device of claim 13, wherein the communication application is further configured to activate an audio interaction mode depending on a location of the user determined based on at least one from a set of: a user input, a Global Positioning Service (GPS) based input, a cellular tower triangulation based input, and a wireless data network location associated with a user.

18. A computer-readable storage medium with instructions stored thereon for facilitating audio-interactive message exchange, the instructions comprising:
activating an audio interaction mode automatically based on at least one from a set of: a setting of a communication device facilitating the message exchange, a location of a user, a status of the user, and a user input;
receiving an audio indication from the user to send a text-based message;
enabling the user to provide a recipient of the text-based message and an audio content of the message through natural language input;
performing speech recognition on the received input;
determining the recipient from the speech recognized content of the input;
transmitting the speech recognized content of the message to the recipient as a text-based message;
receiving a text-based message from a sender;
generating an audio content from the received message by text-to-speech conversion;
playing the audio content to the user;
providing at least one option to the user associated with the played audio content; and
in response to receiving another audio input from the user, performing an action associated with the other audio input.

19. The computer-readable medium of claim 18, wherein the status of the user includes at least one from a set of: a mobile status of the user, an availability status of the user, a position of the communication device, and a configuration of the communication device.

20. The computer-readable medium of claim 18, wherein at least a portion of the speech recognition and the text-to-speech conversion are performed at a server communicatively coupled to a computing device facilitating the audio-interactive message exchange.
